(19) United States
(12) Patent Application Publication
(10) Pub. No.: US 2009/0119183 A1
(43) Pub. Date: May 7, 2009

(54) Method and System For Service Provider Access

(76) Inventors: Imran AZIMI, Pleasanton, CA (US); Syed A. HASAN, Mountain View, CA (US); Shamshad SHAUKAT, San Ramon, CA (US); Amir MOGHUL, Danville, CA (US)

Correspondence Address: ARENT FOX LLP, 1050 CONNECTICUT AVENUE, N.W., SUITE 400, WASHINGTON, DC, 20036, US

(21) Appl. No.: 12/201,373

(22) Filed: Aug. 29, 2008

Related U.S. Application Data
(60) Provisional application No. 60/935,801, filed on Aug. 31, 2007.

(51) Int. Cl. G06Q 30/00; G06Q 40/00; H04M 3/42

(52) U.S. Cl. 705/26; 705/40; 455/414.2

(57) ABSTRACT

Consumer access to service and/or goods providers is provided while avoiding expending consumer and service provider resources and time to place and order with a live service and/or goods provider representative. The present invention uses ubiquitous devices and networks, such as mobile communications devices and networks, that are fast, convenient and consumer-friendly. Furthermore, consumers can obtain information related to a commercial entity based on a geographic location of the user or on an image of the commercial entity captured by a mobile communication device of the user.

This application claims priority from U.S. Provisional Application No. 60/935,801 titled “Method and System for Service Provider Access,” filed on Aug. 31, 2007, which is incorporated by reference herein in its entirety.

### BACKGROUND OF THE INVENTION

1. Field of the Invention

Aspects of the present invention relate generally to a method and system for providing location-based technology for consumer access to service providers. Specifically, the present invention relates to a method and system for allowing consumers to search for specific service providers and place orders for goods or services on the basis of consumers geographic location and/or requirements.

2. Background of the Related Art

There are methods and systems of searching for service providers and for placing orders for goods and/or services with specific service providers that are known in the art. An example of such a method and system is when consumers physically place orders at a physical service provider location, such as a store, eatery or shop. Another such method and system involves placing an order by speaking to a service provider representative over the telephone. Yet another such method and system involves placing an order online, by accessing a service provider Internet web site. All of these methods and systems, however, suffer from various deficiencies, including expending consumer and service provider time and resources for waiting in a queue or line, or on the telephone, to place an order with a live service provider representative. Furthermore, for online orders, each service and/or goods provider must create and maintain a user-friendly website, which can be a tedious task, especially for service and/or goods providers that offer products and/or services that change frequently, such as, for example, daily specials on a restaurant menu. Moreover, when a consumer accesses a service and/or goods provider website the consumer must have an interactive device to browse the website, create an account, and place the order. Such a device can be a keyboard, mouse, computer display, or equivalent, connected to, for example, a laptop computer, mobile device or personal digital assistant (PDA). It should be noted that many more consumers have constant, or at least frequent, access to mobile telephone devices or cell phones, than those that have constant or frequent access to a personal computer, laptop computer, PDA or equivalent.

Accordingly, there is a need in the art for methods and systems that provide consumer access to service and/or goods providers that avoid expending resources and time by both consumers and service and/or goods provider. Such an expense of time can be in the form of physically waiting in line or on a telephone to place and order with a live service and/or goods provider representative.

There also is a need in the art for methods and systems that provide consumer access to service providers that circumvent the need for service providers to create and maintain user-friendly websites and the need for consumers to create accounts and use sophisticated interactive devices. There is yet a further need in the art for methods and systems for computer access to service providers that make use of ubiquitous devices and networks, such as, for example, mobile communications devices and networks. There is yet a further need in the art for methods and systems for providing access to service providers that are fast, convenient, and easy to use for consumers.

### SUMMARY OF THE INVENTION

Various aspects of the present invention solve the above-identified needs, and others, by providing consumer access to service and/or goods providers, while avoiding expending consumer and service provider resources and time, such as physically waiting in line, waiting in queue over the telephone to place and order with a live service and/or goods provider representative. Various aspects of the method and system of the present invention also circumvent the need for service providers to create and maintain user-friendly websites, as well as the need for consumers to create accounts or use sophisticated interactive devices. In addition, various aspects of the method and system of the present invention make use of ubiquitous devices and networks, such as mobile communications devices and networks. These and other aspects of the method and system of the present invention are fast, convenient and consumer-friendly. These and other aspects of the method and system of the present invention may also allow a consumer to effect payment to a service provider for an ordered item or service by using a consumer profile associated with the communication device.

Additional advantages and novel features of the invention will be set forth in part in the description that follows and in part will become more apparent to those skilled in the art upon examination of the following or in connection with the accompanying drawings. Various exemplary aspects of the systems and methods will be described in detail, with reference to the following figures, wherein:

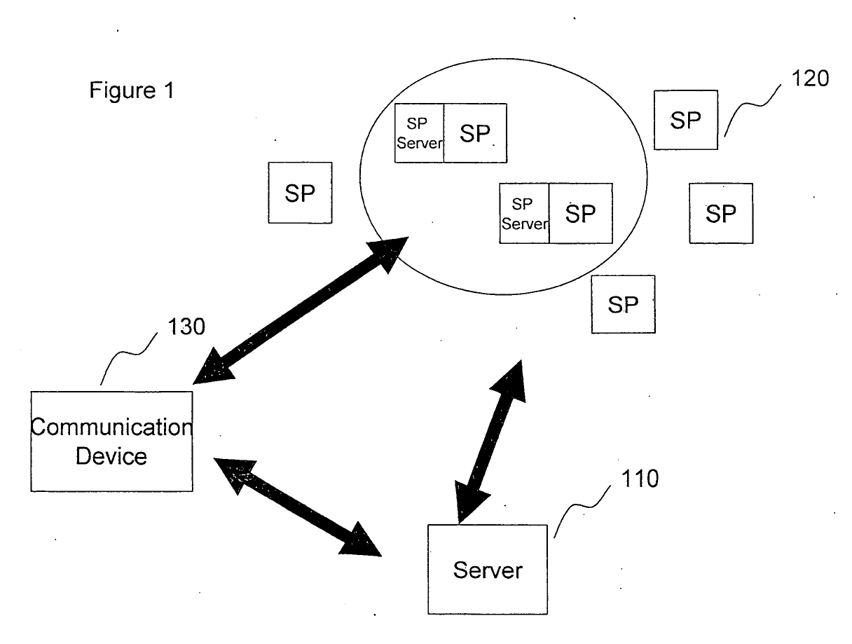

FIG. 1 illustrates an exemplary aspect of the systems according to the present invention;

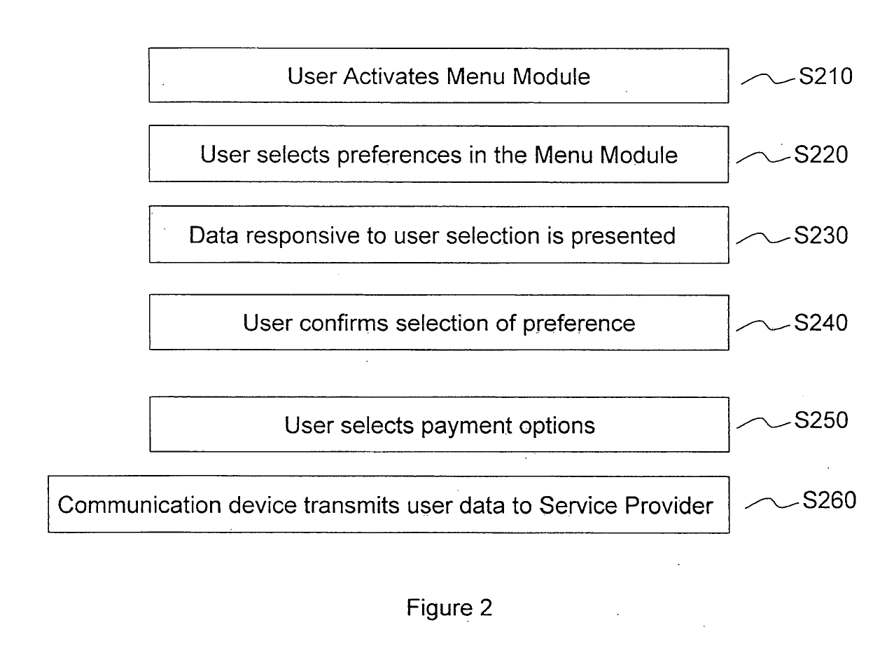

FIG. 2 illustrates an exemplary aspect of the methods according to the present invention;

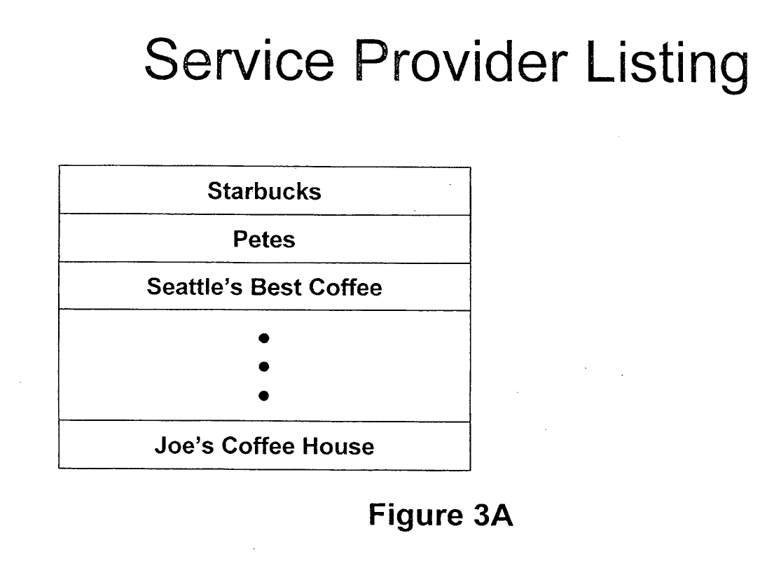

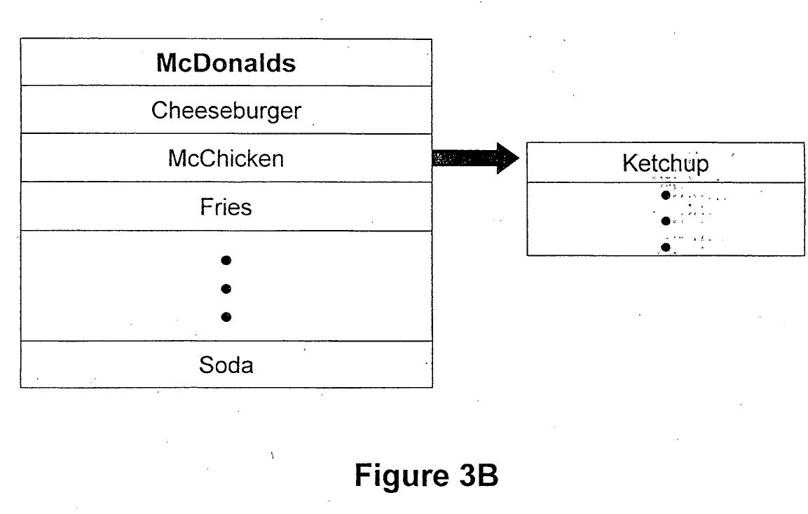

FIGS. 3A-B illustrate exemplary displays according to various aspects of the present invention;

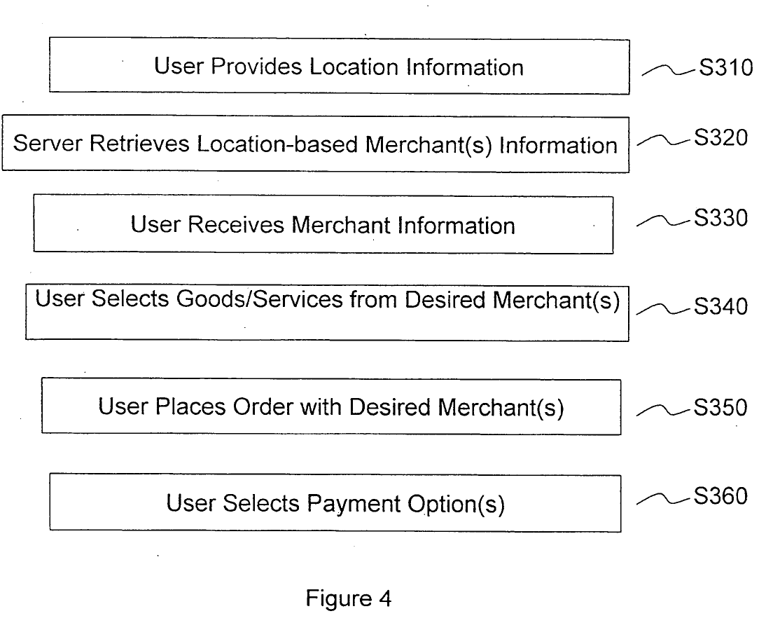

FIG. 4 is a flow chart illustrating a method of providing information about goods and services available to a user based on geographic location data, according to various aspects of the present invention;

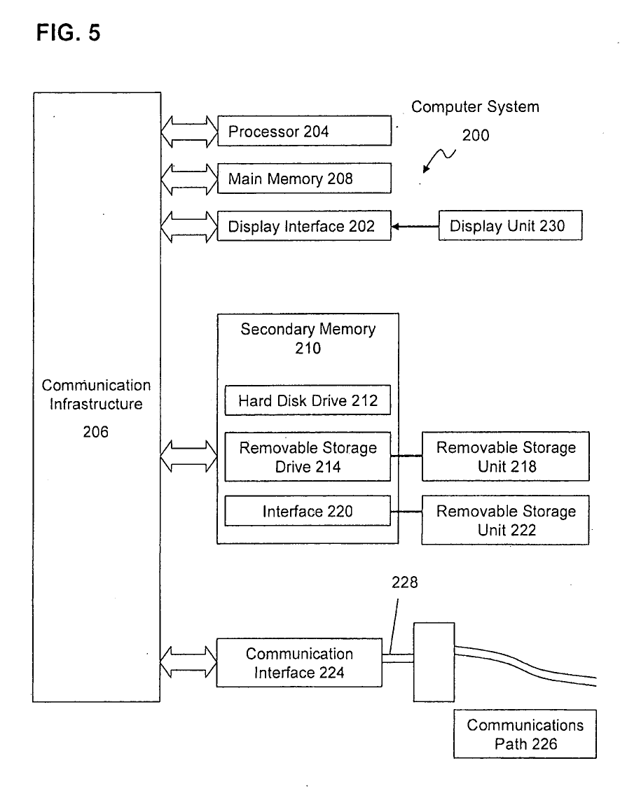

FIG. 5 presents an exemplary system diagram of various hardware components and other features for use in accordance with an aspect of the present invention; and

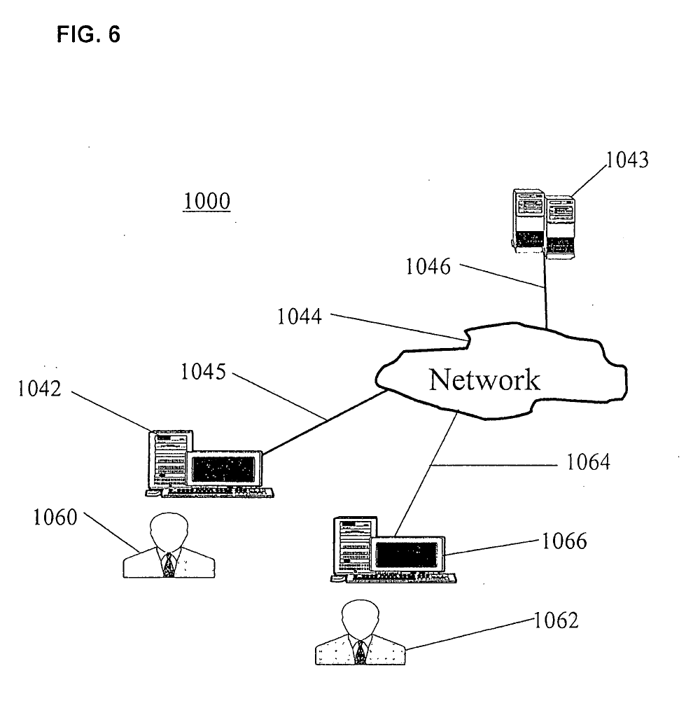

FIG. 6 is a block diagram of various exemplary system components, in accordance with an aspect of the present invention.

### DETAILED DESCRIPTION

Preferred aspects of the present invention and their features and advantages may be understood by referring to the drawings and accompanying attachments, like numerals being used for like corresponding parts in the various drawings.

FIG. 1 illustrates an exemplary aspect of systems according to the present invention. Various aspects of the present invention take advantage of the mobile communications infrastructure that is available today and allow a consumer mobile telephone or other communications device 130, to interactively access the content of a service provider 120. Upon allowing access, the consumer (interchangeably referred to herein as a user or requester) can compose an order for goods and/or services or other request for information via the communication device 130, and communicate that request directly or via server 110 to the service provider 120 for fulfillment of the order or to receive response to the request for information.

In various exemplary aspects, the present invention is based on a framework that allows the consumer, via the communications device 130, to access the service provider 120, such as, for example, an eatery. An eatery may be a restaurant, a coffee house, a fast food place, or an other entity serving food or beverages, and may be located in, for example, a mall, an airport, or on the street. The goods and/or services that are offered by the service provider 120 such as, for example, a restaurant menu, may then be communicated and displayed on the consumer's communication device 130. The consumer may then make a selection via the communication device 130 of a specific item and/or service, and the selection may then be communicated via the communication device 130 to the service provider for fulfillment of the order. As an example, the consumer may select a specific menu choice, communicated via the communication device 130 to the service provider restaurant 120, for fulfillment of the menu selection.

According to exemplary aspects of the present invention, the consumer may make selections and provide other input for operations via, for example, interactive voice response (IVR), or other voice activated mechanism.

According to various exemplary aspects, the present invention provides a complete communication cycle. Once the order is placed with the service provider 120, the service provider 120 may communicate acceptance or denial of the order, or other related communication, to the communication device 130 of the requester, via a messaging interface such as, for example, a short messaging service (SMS). In the case of a restaurant, for example, an SMS may be sent from the service provider 120 back to the user via the communication device 130 stating that the order has been received, and including other information, such as a time stamp, order number, or time of pick-up, for example. Order fulfillment status information, such as “the order will be pending for 20 minutes” or “the order is ready for pickup,” may also be communicated in a similar manner. All information may be communicated directly between the service provider 120 and the requester's communication device 130.

In accordance with exemplary aspects of the present invention, a user can create a user profile and can register the user profile with a central entity such as a server 110. The user may, for example, include in the profile search criteria for favorite search items and/or service providers, spending limits, to ensure that the user's communication device 130 is not being used without authorization, preferences that indicate certain payment options, and the like. In various exemplary aspects, to ensure confidentiality of the consumer financial information, the actual financial information may be saved in the server 110, while the profile is created on the basis of that information and saved in a memory of the communication device 130, so that the profile contains, for example, labels or other indicators for financial data, rather than actual financial data. For example, complete credit card information for several consumer credit cards may be saved on the central server 110, but the consumer profile stored in a memory of the communication device 130 may only indicate a label such as “preferred credit card” or “secondary credit card,” in lieu of the actual credit card information. Flexible billing may also be accomplished by using third-party billing, prepaid account setup in advance, or credit card swipe at terminals located at the point of transaction or sale.

Furthermore, in various exemplary aspects, a consumer may create several different consumer profiles with different preferences and methods of payment, for example. Each consumer profile may be available for download or installation via different means in the consumer communication device 130. Thus, a user using the method and system in accordance with aspects of the present invention on the user's communication device 130 may access the user's profile stored at the central server or servers 110. Upon authenticating the user, the server 110 may send the user's profile to the communication device 130 for download and/or installation. Upon download/installation of the profile, the user can submit orders for goods and/or services, select payment information and/or order delivery options via, e.g., a user-friendly input/selection mechanism such as a drop down menu and/or labels that the user created in the user's profile, as illustrated in FIGS. 3A and 3B.

In various exemplary aspects of the present invention, when submitting an order via the user's communication device 130, the user may avoid inputting actual information into the device. Instead, the user may select predefined values that are saved in the user's profile on the server 110. Therefore, no confidential financial data may be transferred over a mobile communications network to the communication device 130. According to various exemplary aspects of the present invention, the user may also have the option of inputting actual credit card or other financial information into the user's communications device 130 as a method of payment. This actual financial information may be transmitted, for example, via Secure Sockets Layer (SSL) or other secure connection.

Alternatively, in one exemplary aspect of the present invention, actual credit card or other financial or confidential information (such as a password, for example) may be encrypted directly on the user's communication device 130.

In various exemplary aspects of the present invention, in line with the goal of convenience and ease of use of the method and system of the present invention, are based on limiting or minimizing keying an input that a user makes when creating orders and/or inputting other related information into the consumer's communication device. The creation of the consumer profile, which allows the user to select from predefined values, labels and/or dropdown menus, rather than typing or otherwise inputting information into a small-keyboard, small-screen device, such as a mobile telephone, assists with achieving minimal consumer key input. Such an option is illustrated in FIGS. 3A and 3B.

In one exemplary aspect of the present invention, the central server or servers 110 may be accessed using, e.g. the Internet or other network, such as an extranet. Most mobile telephone users today typically have Internet access provided via their mobile service providers.

The service providers 120, in accordance with one exemplary aspect, may subscribe to the service provided by server 110, and indicate the goods and/or services that they want to offer to consumers. The server 110 may convert that information (e.g., a restaurant menu) into an appropriate format for display on a small-screen consumer communication device 130. Upon conversion, the content may be hosted at a multitude of locations, such as central server(s) 110, a server or other network information technology (IT) location associated with the service provider, on a communication device 130, or elsewhere. The user creating the order may be redirected to the content, for example, via a high-performance data transfer (HPDT).

It should be noted that, in accordance with one exemplary aspect of the present invention, any user can become a service provider 120 by composing a service offering directly from the user's communication device 130. The service offering may also be composed by other means, such as using an Internet portal. The service offering may be activated, for example, by sending an activation command to the central server. Once activated, the service offering is accessible to other users.

If a user wants to offer hourly consulting services, for example, the user may use the user's communication device 130 to activate a previously configured consulting service offering, to modify and activate a previously configured consulting service offering, or to compose a new consulting service offering. Once activated, the user's consulting service offering is available to other users. A consumer, for example, searching for the type of consulting service offered, would be able to find and compose a service request to the offeror from the consumer's communication device 130. This feature of the present invention provides ease of access and use for both service providers 120 and consumers, and provides a way for consumers to offer services directly from their communication devices 130.

The consumer profile may be created, for example, via a central institution registration website, where the user registers as a subscriber and creates one or more profiles depending on the user's preferences that are stored on server or servers 110. Upon registration, in one aspect of the present invention, a service application is downloaded or otherwise installed on the user's communication device 130. The service application may be pre-installed on the user's communication device 130. The service application allows the user to access the central server(s) 110, on which the user's profile is stored.

Once the profiles are created and activated, in one exemplary aspect of the present invention, the user can download that profile into the communication device 130, and the user's profile may appear as one of the login parameters for logging in to the central server(s) 110. When logging into the central server(s) 110 via the service application for accessing the user's profile(s), the user may be authenticated at different levels to ensure confidentiality. Each service application installed on a communication device may have, in accordance with one exemplary aspect of the present invention, an associated unique identifier. The level of security each user desires may, for example, be associated with this unique identifier. In a large company environment with multiple employees, the company may want to create a certain profile for its employees, including use of a specific payment option, such as a specific credit card. As another example, a user may want to limit the use of a specific profile to a specific hardware device, such as one that has a unique serial number. These and various other security mechanisms are available to users to prevent misuse.

FIG. 2 illustrates an exemplary aspect of methods according to the present invention. Upon login, the user may use the user's profile to create searches. In the case of a restaurant menu, for example, the user can activate a menu module during step S210. During step S220, the user may select items and indicate specific preferences, such as portion size or preferred condiments in the example of a restaurant menu, as illustrated on FIG. 3A. It should be noted that these preferences may be selected via the user's communication device 130 in FIG. 1 without using mobile network time. That is, once the search results are downloaded on the user's communication device 130, the user need not have access to the server to communicate with the service provider 110, as all the relevant information is stored locally at the user's communication device 130. Thus, the user can, for example, review the ordered items, remove or add items, make modifications to orders, and take other related actions. Once the user has selected preferences on the communication device 130 during step S220, the method continues to step S230.

In step S230, in accordance with various aspects of the invention, once the selection is made by the user, the selection may be communicated to the service provider. Once the service provider receives the user's selection via the user's communication device, the service provider may respond to the user via the communication device and may provide the user with relevant information such as, for example, whether the order can be completed, the time frame in which the order can be completed, whether any changes to the order will be necessary such as, for example, different condiments to a menu order, and the like. Once the relevant data is transmitted back to the user during step S230, the method continues to step S240, where the user may confirm the selection. Once the user confirms the selection during step S240, then the method continues to step S250.

Once the confirmation is performed during step S240, the user may select a delivery method or a payment option during step S250. For example, the user may select to pick up the order, or select a delivery option. During step S250, the user may also select whether payment will be made by credit, electronic transfer, or cash at the point of delivery, for example. The communication device 130 may have payment option screens to select delivery and payment options. According to various aspects of the present invention, the payment option screens may be specific to each service provider. For example, if the service provider, such as a restaurant, does not deliver, delivery will not appear as a selection option on the delivery options screen. Once the user selects payment options during step S250, the method continues to step S260, where the communication device transmits user date to the service provider.

In accordance with various aspects of the present invention, the Consumer's communication device may be equipped with a geographic location feature, such as, for example, a Global Positioning System (GPS) or any other location-based technology. This feature may assist the consumer in locating a service provider, from which the consumer may be, for example, picking up an order. This feature may also assist the service provider in locating the consumer when, e.g., delivering an order.

According to various aspects of the present invention, and with reference to FIG. 1, a user of the mobile communication device 130 can obtain access to a service provider 120 even when the user may not be aware of the presence of the service provider 120 in a given geographic location. For example, a user or consumer may be located in a specific geographic location and may desire to know the types of services and goods that are available for purchase in that location. According to various aspects of the current invention, the user may provide, e.g., via GPS data transmittal via the user's communication device 130, a server such as the server 110 with information concerning the user's location, and the server may provide the user with information about service providers 120, such as vendors or merchants located within the vicinity of the user's location, or within the vicinity of a location indicated by the user.

FIG. 4 shows a flow chart illustrating a method of providing information about goods and services available to a user based on geographic location, in accordance with aspects of the present invention. In FIG. 4, the user provides location information to a server at step S310. According to various aspects of the present invention, the location information may be the location of the user, which may be provided to the server by the user via manual entry of the address of the location, via GPS data, where the server automatically detects the position of the user, or via any other location-based technology, such as via wireless technology (WiFi), Radio Frequency Identification (RFID), triangulation, or other technique designed to determine the location of a mobile communication device, and consequently, of a user of the mobile communication device. These techniques contribute to determining the user's proximity. Accordingly, the server receives location information relevant to the user on the basis of presence and proximity using a combination of software and hardware.

It should be noted that the location that is relevant to the user may be the actual location of the user, but may also be the location of any address or landmark that the user may be interested in and may enter in the mobile communication device, For example, the user may enter an address other than the address at which the user is currently located, or may provide to the server an image of a given location, even if the user is not at that time situated at that location. The user may capture a photograph of the location via the mobile communication and image capturing device such as, for example, a cellular phone, and transmit the captured image to the server, whether or not the user is actually at the location in question. Thus, capture of the image and proximity to the user may be used to provide a user with access to services or goods. The user may also capture the image from a printed publication such as a magazine, or may capture the image of a building physically located in front of the user.

Once the server receives the information provided by the user regarding a given geographic location, the method continues to step S320. The server may rely on a database or other mapping technique to identify any merchants, service and/or goods providers that are located in the vicinity of the relevant location in step S320. In the case where the user provides a captured image of the location such as, for example, the image of a building or a mall, the server may search a database or data mapping storage repository containing images of building or malls within a certain city, state, or country, to match the image of the building or mall captured by the user's communication device and transmitted to the server, and thus to determine an address of that building or mall. The database may contain image attributes, and may include a relational database server that stores images provided from image capture devices or snapshots uploaded by the user. The database may also be part of an image processing server that may categorize the uploaded images based on image quality and image source, such as a live snapshot, a magazine picture or a drawing. The image processing server may also match the uploaded image with images already existing in the database, and may also update the database with new uploaded images.

According to various aspects of the current invention, the identification of the building may also be achieved by the user presenting or selecting a category of potential businesses. According to various aspects of the current invention, the identification can also be achieved by a combination of a location determination and the user selecting a category of businesses. Once the address of the building or mall is identified, the method continues to step S330. The user receives information about merchants, services and/or goods providers located in the vicinity of the relevant location in step S330. The information about the merchants or goods and services providers may be determined by querying a database accessible by the server to determine, based on an address of the relevant location, a list of any merchants, service and/or goods providers, located at that relevant address or within a vicinity of that relevant address. For example, the server may provide the user with a list of merchants or service and/or goods providers present in a building or mall, or within a vicinity of the building or mall.

Next, the user selects a desired merchant or services and/or goods provider, and may select the types of goods and services to be ordered from the selected merchants in step S340. The user then places one or more orders with the selected merchants in step S350, and the user selects a method of payment in step S360.

It should be noted that although aspects of the present invention are described in relation to a consumer-merchant relationship, variations may include gaming technology, law enforcement, commercial transactions such as, for example, real estate transactions and the like, transportation industry such as aviation, mobile to mobile commerce, and the like. For example, in gaming technology, two players may use their respective mobile communication devices to locate each other via location-based technology and simulate ground combat, aerial combat, or the like.

The present invention may be implemented using hardware, software, or a combination thereof and may be implemented in one or more computer systems or other processing systems. In one aspect, the present invention is directed toward one or more computer systems capable of carrying out the functionality described herein. An example of such a computer system 200 is shown in FIG. 5.

Computer system 200 includes one or more processors, such as processor 204. The processor 204 is connected to a communication infrastructure 206 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data,

In alternative aspects of the present invention, secondary memory 210 may include other similar devices for allowing computer programs or other instructions to be loaded into computer system 200. Such devices may include, for example, a removable storage unit 222 and an interface 220. Examples of such devices may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 280, a hard disk installed in hard disk drive 270, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 210 to perform the features of the present invention. Accordingly, such computer programs represent controllers of the computer system 200.

In an aspect of the present invention where the invention is implemented using software, the software may be stored in a computer program product and loaded into computer system 200 using removable storage drive 214, hard drive 212, or communications interface 220. The control logic (software), when executed by the processor 204, causes the processor 204 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In accordance with yet another aspect, the invention is implemented using a combination of both hardware and software.

FIG. 6 is a block diagram of various exemplary system components, in accordance with various exemplary aspects of the present invention. FIG. 6 shows a communication system 1000 usable in accordance with the present invention. The communication system 1000 includes one or more accessors 1060, 1062 (also referred to interchangeably herein as one or more “users”) and one or more terminals 1042, 1066. In accordance with one aspect of the present invention, data may be input and/or accessed by accessors 1060, 1064 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In accordance with another aspect, the method and system of the present invention operate in a stand-alone environment, such as on a single terminal.

While the present invention has been described in connection with various aspects, it will be understood by those skilled in the art that variations and modifications of the various aspects described above may be made without departing from the scope of the invention. Other variations will be apparent to those skilled in the art from a consideration of the specification or from a practice of the invention disclosed herein.

What is claimed is:

1. A method for facilitating a transaction between a user and a commercial entity the method comprising:
identifying the commercial entity based on at least one of a geographic location of the user and an image of the commercial entity captured by a mobile communication device of the user;
accessing information about the commercial entity via the mobile communication device;
initiating the transaction between the user and the commercial entity via the mobile communication device; and
completing the transaction between the user and the commercial entity.

2. The method of claim 1, wherein initiating the transaction comprises placing an order for at least one of goods and services.

3. The method of claim 2, wherein the commercial entity comprises a merchant.

4. The method of claim 3, wherein accessing the information comprises accessing a list of goods and services provided by the merchant.

5. The method of claim 3, wherein placing the order comprises receiving confirmation from the merchant that the order has been placed.

6. The method of claim 1, wherein completing the transaction comprises performing payment for the transaction.

7. The method of claim 6, wherein performing payment comprises selecting a payment option.

8. The method of claim 7, wherein the payment option comprises at least one of credit card swipe at a location of the commercial entity, third party billing, and preparing account billing.

9. The method of claim 1, wherein completing the transaction comprises performing payment via the mobile communication device.

10. The method of claim 1, wherein identifying the commercial entity comprises obtaining at least one of a location of the commercial entity and a selection of a category of business by the user.

11. The method of claim 10, wherein the location of at least one of the user and the commercial entity is obtained via location-based technology.

12. The method of claim 11, wherein location-based technology comprises one of global positioning system, wireless communication, radio frequency, and triangulation.

13. The method of claim 10, wherein obtaining a location of the commercial entity based on an image of the commercial entity captured by the mobile communication device comprises:
comparing the captured image of the commercial entity to a database; and
determining a location of the commercial entity based on the comparison.

14. The method of claim 13, wherein the image captured is a representation of the commercial entity.

15. The method of claim 14, wherein the representation of the commercial entity comprises a drawing of the commercial entity.

16. The method of claim 13, wherein comparing the captured image of the commercial entity is performed by one or more servers located remotely from the communication device.

17. The method of claim 16, wherein the database is located on the one or more servers.

18. A system for facilitating a transaction between a user and a commercial entity, the system comprising:
an identifying module for identifying the commercial entity based on at least one of a geographic location of the user and an image of the commercial entity captured by a mobile communication device of the user;
an accessing module for accessing information about the commercial entity via a mobile communication device;
a placing module for placing an order for at least one of goods and services offered by the commercial entity; and
a selecting module for selecting a payment option for payment of the placed order and effecting payment of the placed order,

19. A system for facilitating a transaction with a commercial entity, the system comprising:
a processor;
a user interface functioning via the processor; and
a repository accessible by the processor; wherein
the commercial entity is identified based on at least one of a geographic location of the user and an image of the commercial entity captured by a mobile communication device of the user;
information about the commercial entity is accessed via a mobile communication device;
an order for at least one of goods and services offered by the commercial entity is placed;
a payment option for payment of the placed order is selected; and
payment of the placed order is effected.

20. The system of claim 19, wherein the processor is housed on a terminal.

21. The system of claim 20, wherein the terminal is selected from a group consisting of a personal computer, a minicomputer, a main frame computer, a microcomputer, a hand held device, and a telephonic device.

22. The system of claim 19, wherein the processor is housed on a server.

23. A computer program product for facilitating a transaction between a user and a commercial entity comprising a computer usable medium having control logic stored therein for causing a computer to exchange user-generated community information, the control logic comprising:
first computer readable program code means for computer readable program code means for identifying the commercial entity based on at least one of a geographic location of the user and an image of the commercial entity captured by a mobile communication device of the user;
second computer readable program code means for accessing information about the commercial entity via a mobile communication device;
third computer readable program code means for placing an order for at least one of goods and services offered by the commercial entity; and
fourth computer readable program code means for selecting a payment option for payment of the placed order and effecting payment of the placed order.

24. A method for facilitating a placement of an order between a client and an eatery, the method comprising:
identifying the eatery based on at least one of a geographic location of the client and an image of the eatery captured by a mobile communication device of the client;
accessing information about the eatery via the mobile communication device;
placing the order by the client with the eatery via the mobile communication device; and
completing payment for the order by the client to the eatery.

25. The method of claim 24, wherein accessing the information comprises accessing a menu provided by the eatery.

26. The method of claim 24, wherein placing the order comprises receiving confirmation from the eatery that the order has been placed.

27. The method of claim 24, wherein completing payment comprises selecting a payment option.

28. The method of claim 27, wherein the payment option comprises at least one of credit card swipe at a location of the eatery, third party billing, and preparing account billing.

29. The method of claim 24, wherein completing payment comprises completing payment via the mobile communication device.

30. The method of claim 24, wherein identifying the eatery comprises obtaining at least one of a location of the eatery and a selection of a category of business by the client.

31. The method of claim 30, wherein the location of at least one of the client and the eatery is obtained via location-based technology.

32. The method of claim 31, wherein location-based technology comprises one of global positioning system, wireless communication, radio frequency, and triangulation.

33. The method of claim 1, wherein initiating the transaction comprises initiating the transaction via voice-activation.

34. The method of claim 24, wherein placing the order comprises placing the order via voice-activation.

35. The method of claim 1, wherein at least one of identifying the commercial entity, accessing information about the commercial entity, initiating the transaction between the user and the commercial entity, and completing the transaction between the user and the commercial entity is performed using a secure connection.

36. The method of claim 24, wherein at least one of identifying the eatery, accessing information about the eatery, placing the order, and completing payment for the order is performed using a secure connection.
